(19) United States
(12) Patent Application Publication
(10) Pub. No.: US 2026/0155923 A1
(43) Pub. Date: Jun. 4, 2026

(54) WIRELESS COMMUNICATION DEVICES AND WIRELESS COMMUNICATION METHODS FOR DETERMINING DATA

(71) Applicant: GUANGDONG OPPO MOBILE TELECOMMUNICATIONS CORP., LTD., Dongguan (CN)

(72) Inventor: Yinan QI, Dongguan (CN)

(21) Appl. No.: 19/457,369

(22) Filed: Jan. 23, 2026

Related U.S. Application Data
(63) Continuation of application No. PCT/CN2023/109967, filed on Jul. 28, 2023.

(51) Int. Cl. H04L 5/00

(52) U.S. Cl. CPC H04L 5/0044

(57) ABSTRACT

A wireless communication method for determining data includes: receiving, by a first communication device from a second communication device, a physical layer convergence protocol (PLCP) protocol data unit (PPDU) format and decoding, by the first communication device, the PPDU format, where the PPDU format includes a preamble with spreading and a media access control protocol data unit (MPDU).

### CROSS-REFERENCE TO RELATED APPLICATION

This application is a Continuation Application of International Application No. PCT/CN2023/109967 filed on Jul. 28, 2023, which is incorporated herein by reference in its entirety.

### TECHNICAL FIELD

The present disclosure relates to the field of communication technologies, and more particularly, to wireless communication devices and wireless communication methods for determining data, wherein the data may be a physical layer convergence protocol (PLCP) protocol data unit (PPDU) format, and the PPDU format may be for direct sequence spread spectrum (DSSS) based ambient power (AMP).

### BACKGROUND

In current ambient power (AMP) designs, two operation frequency bands are currently considered including sub 1 GHz (S1G) and 2.4 GHz. The frequency band of 2.4 GHz is the traditional frequency band for Wi-Fi operation. Most of Wi-Fi devices use orthogonal frequency division multiplexing (OFDM) and its complexity is not affordable to AMP devices. In Institute of Electrical and Electronics Engineers (IEEE) 802.11b, direct sequence spread spectrum (DSSS) based design is adopted and its complexity is relatively low compared with OFDM and thus can be considered for AMP devices. However, in the DSSS based design, a wide band operation may cause higher complexity and power consumption. This innovation proposes narrow band operation to reduce the complexity and power consumption while further compatible with existing 802.11b system.

Therefore, there is a need for wireless communication devices and wireless communication methods for determining data, which can reduce complexity, reduce power consumption, and/or provide a backward compatibility.

### SUMMARY

An object of the present disclosure is to propose wireless communication devices and wireless communication methods for determining data.

In a first aspect of the present disclosure, a wireless communication method for determining data includes receiving, by a first communication device from a second communication device, a physical layer convergence protocol (PLCP) protocol data unit (PPDU) format and decoding, by the first communication device, the PPDU format, wherein the PPDU format includes a preamble with spreading and a media access control protocol data unit (MPDU).

In a second aspect of the present disclosure, a first wireless communication device includes a receiver configured to receive from a second communication device, a physical layer convergence protocol (PLCP) protocol data unit (PPDU) format and a decoder configured to decode the PPDU format, wherein the PPDU format includes a preamble with spreading and a media access control protocol data unit (MPDU).

In a third aspect of the present disclosure, an access point (AP) includes a receiver configured to receive from an ambient power (AMP) device, a physical layer convergence protocol (PLCP) protocol data unit (PPDU) format and a decoder configured to decode the PPDU format, wherein the PPDU format includes a preamble with spreading and a media access control protocol data unit (MPDU).

In a fourth aspect of the present disclosure, an access point (AP) includes a memory, a transceiver, and a processor coupled to the memory and the transceiver. The AP is configured to perform the above method.

In a fifth aspect of the present disclosure, an ambient power (AMP) device includes a receiver configured to receive from an access point (AP), a physical layer convergence protocol (PLCP) protocol data unit (PPDU) format and a decoder configured to decode the PPDU format, wherein the PPDU format includes a preamble with spreading and a media access control protocol data unit (MPDU).

In a sixth aspect of the present disclosure, an ambient power (AMP) device includes a memory, a transceiver, and a processor coupled to the memory and the transceiver. The AMP device is configured to perform the above method.

In a seventh aspect of the present disclosure, a non-transitory machine-readable storage medium has stored thereon instructions that, when executed by a computer, cause the computer to perform the above method.

In an eighth aspect of the present disclosure, a chip includes a processor, configured to call and run a computer program stored in a memory, to cause a device in which the chip is installed to execute the above method.

In a ninth aspect of the present disclosure, a non-transitory computer readable storage medium, in which a computer program is stored, causes a computer to execute the above method.

In a tenth aspect of the present disclosure, a computer program product includes a computer program, and the computer program causes a computer to execute the above method.

In an eleventh aspect of the present disclosure, a computer program causes a computer to execute the above method.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures.

FIG. 1 is a block diagram of a first wireless communication device according to an embodiment of the present disclosure.

FIG. 2 is a block diagram of a first wireless communication device according to an embodiment of the present disclosure.

FIG. 3 is a flowchart illustrating a wireless communication method for determining data performed by a first wireless communication device according to an embodiment of the present disclosure.

FIG. 4 is a block diagram of an access point (AP) according to an embodiment of the present disclosure.

FIG. 5 is a block diagram of an AP according to an embodiment of the present disclosure.

FIG. 6 is a flowchart illustrating a communication method for determining data performed by an AP according to an embodiment of the present disclosure.

FIG. 7 is a block diagram of an ambient power (AMP) device according to an embodiment of the present disclosure.

FIG. 8 is a block diagram of an AMP device according to an embodiment of the present disclosure.

FIG. 9 is a flowchart illustrating a wireless communication method for determining data performed by an AMP device according to an embodiment of the present disclosure.

FIG. 10 is a schematic structural diagram illustrating a physical layer convergence protocol (PLCP) protocol data unit (PPDU) format.

FIG. 11 is a schematic structural diagram illustrating a PPDU format according to an embodiment of the present disclosure.

FIG. 12 is a schematic structural diagram illustrating a PPDU format according to an embodiment of the present disclosure.

FIG. 13 is a schematic structural diagram illustrating a PPDU format according to an embodiment of the present disclosure.

FIG. 14 is a schematic structural diagram illustrating a PPDU format according to an embodiment of the present disclosure.

FIG. 15 is a schematic structural diagram illustrating a PPDU format according to an embodiment of the present disclosure.

FIG. 16 is a schematic structural diagram illustrating a PPDU format according to an embodiment of the present disclosure.

FIG. 17 is a schematic structural diagram illustrating a PPDU format according to an embodiment of the present disclosure.

FIG. 18 is a block diagram of an example of a computing device according to an embodiment of the present disclosure.

FIG. 19 is a block diagram of a communication system according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

In AMP design, two operation frequency bands are considered including S1G and 2.4 GHZ. The frequency band of 2.4 GHz is a frequency band for Wi-Fi operation, and AMP devices and APs can be easily implemented with backward compatibility to reduce deployment cost. However, most of the Wi-Fi devices use OFDM and its complexity is not affordable to AMP devices. In 802.11b, DSSS based design is adopted and its complexity is relatively low compared with OFDM and thus can be considered for AMP devices, especially in UL. Considering the channel bandwidth of 802.11b is 22 MHz, this wide band operation may cause higher complexity and power consumption. Some embodiments of this disclosure proposes narrow band operation to reduce the complexity and power consumption while further compatible with existing 802.11b system.

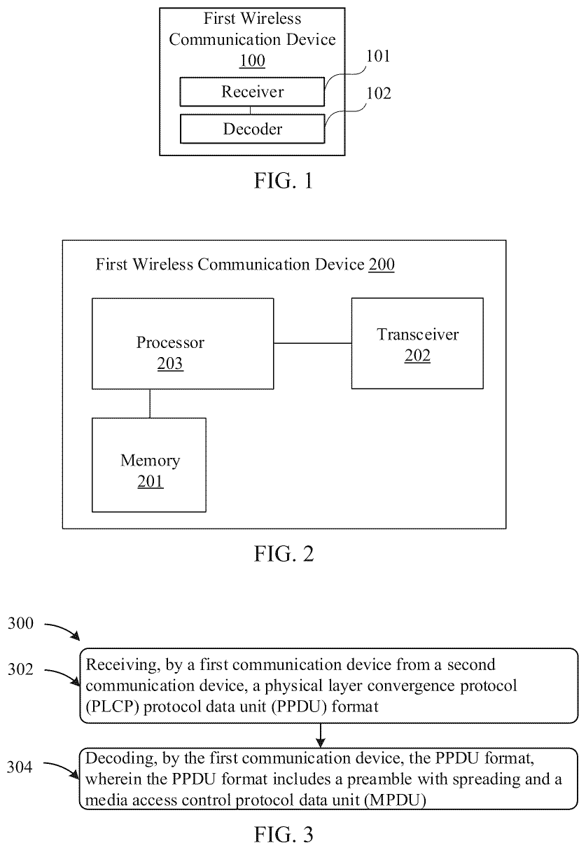

FIG. 1 illustrates an example of a first wireless communication device 100 according to an embodiment of the present application. The first wireless communication device 100 is configured to implement some embodiments of the disclosure. Some embodiments of the disclosure may be implemented into the first wireless communication device 100 using any suitably configured hardware and/or software. The first wireless communication device 100 includes a receiver 101 configured to receive from a second communication device, a physical layer convergence protocol (PLCP) protocol data unit (PPDU) format and a decoder 102 configured to decode the PPDU format, wherein the PPDU format includes a preamble with spreading and a media access control protocol data unit (MPDU). This can reduce complexity, reduce power consumption, and/or provide a backward compatibility.

FIG. 2 illustrates an example of a first wireless communication device 200 according to an embodiment of the present disclosure. The first wireless communication device 200 is configured to implement some embodiments of the disclosure. Some embodiments of the disclosure may be implemented into the first wireless communication device 200 using any suitably configured hardware and/or software. The first wireless communication device 200 may include a memory 201, a transceiver 202, and a processor 203 coupled to the memory 201 and the transceiver 202. The processor 203 may be configured to implement proposed functions, procedures and/or methods described in this description. Layers of radio interface protocol may be implemented in the processor 203. The memory 201 is operatively coupled with the processor 203 and stores a variety of information to operate the processor 203. The transceiver 202 is operatively coupled with the processor 203, and the transceiver 202 transmits and/or receives a radio signal. The processor 203 may include application-specific integrated circuit (ASIC), other chipset, logic circuit and/or data processing device. The memory 201 may include read-only memory (ROM), random access memory (RAM), flash memory, memory card, storage medium and/or other storage device. The transceiver 202 may include baseband circuitry to process radio frequency signals. When the embodiments are implemented in software, the techniques described herein can be implemented with modules (e.g., procedures, functions, and so on) that perform the functions described herein. The modules can be stored in the memory 201 and executed by the processor 203. The memory 201 can be implemented within the processor 203 or external to the processor 203 in which case those can be communicatively coupled to the processor 203 via various means as is known in the art.

In some embodiments, the transceiver 202 is configured to receive from a second communication device, a physical layer convergence protocol (PLCP) protocol data unit (PPDU) format, and the processor 203 is configured to decode the PPDU format, wherein the PPDU format includes a preamble with spreading and a media access control protocol data unit (MPDU). This can reduce complexity, reduce power consumption, and/or provide a backward compatibility.

FIG. 3 is an example of a communication method 300 for determining data by a first wireless communication device according to an embodiment of the present disclosure. The communication method 300 for determining data is configured to implement some embodiments of the disclosure. Some embodiments of the disclosure may be implemented into the communication method 300 for determining data using any suitably configured hardware and/or software. In some embodiments, the communication method 300 for determining data includes: an operation 302, receiving, by a first communication device from a second communication device, a physical layer convergence protocol (PLCP) protocol data unit (PPDU) format, and an operation 304, decoding, by the first communication device, the PPDU format, wherein the PPDU format includes a preamble with spreading and a media access control protocol data unit (MPDU). This can reduce complexity, reduce power consumption, and/or provide a backward compatibility.

In some embodiments, the first communication device is an ambient power (AMP) device, and the second communication device is an access point (AP). In some embodiments, the first communication device is an AP, and the second communication device is an AMP device. In some embodiments, the preamble with spreading includes a sync part with spreading. In some embodiments, the sync part has backward compatibility, and a sync sequence of the sync part is configured to indicate a following PPDU. In some embodiments, a bandwidth of the MPDU is narrower than a bandwidth of the sync part. In some embodiments, the sync sequence is pre-spread and pre-filtered.

In some embodiments, the preamble with spreading further includes a start of frame delimiter (SFD). In some embodiments, a bandwidth of the SFD is narrower than the bandwidth of the sync part. In some embodiments, a bandwidth of the SFD is equal to the bandwidth of the sync part. In some embodiments, the PPDU format further includes a header. In some embodiments, a bandwidth of the header is narrower than the bandwidth of the sync part. In some embodiments, a bandwidth of the header is equal to the bandwidth of the sync part. In some embodiments, the header includes none or at least one of signal part, a service part, or a length part.

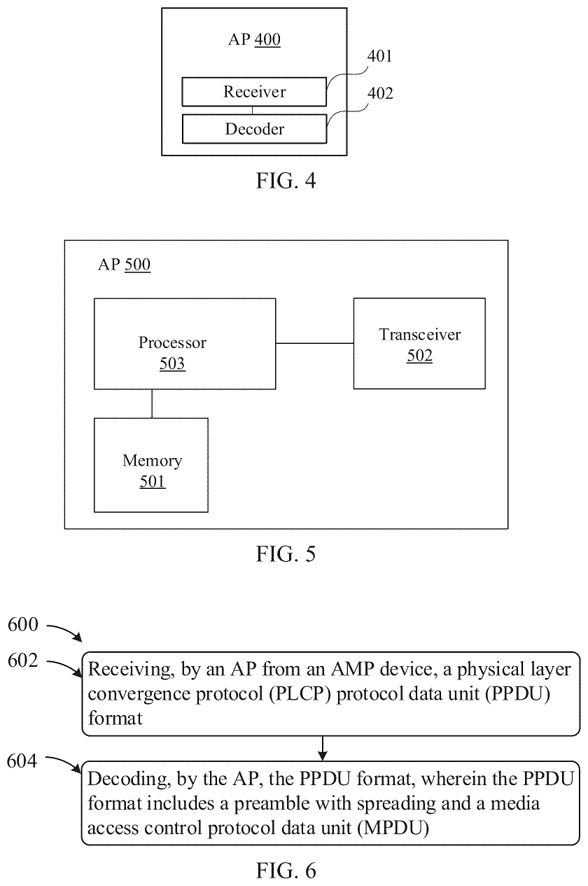

FIG. 4 illustrates an example of an AP 400 according to an embodiment of the present application. The AP 400 is configured to implement some embodiments of the disclosure. Some embodiments of the disclosure may be implemented into the AP 400 using any suitably configured hardware and/or software. The AP 400 includes a receiver 401 configured to receive from an AMP device, a physical layer convergence protocol (PLCP) protocol data unit (PPDU) format and a decoder 402 configured to decode the PPDU format, wherein the PPDU format includes a preamble with spreading and a media access control protocol data unit (MPDU). This can reduce complexity, reduce power consumption, and/or provide a backward compatibility.

FIG. 5 illustrates an example of an AP 500 according to an embodiment of the present disclosure. The AP 500 is configured to implement some embodiments of the disclosure. Some embodiments of the disclosure may be implemented into the AP 500 using any suitably configured hardware and/or software. The AP 500 may include a memory 501, a transceiver 502, and a processor 503 coupled to the memory 501 and the transceiver 502. The processor 503 may be configured to implement proposed functions, procedures and/or methods described in this description. Layers of radio interface protocol may be implemented in the processor 503. The memory 501 is operatively coupled with the processor 503 and stores a variety of information to operate the processor 503. The transceiver 502 is operatively coupled with the processor 503, and the transceiver 502 transmits and/or receives a radio signal. The processor 503 may include application-specific integrated circuit (ASIC), other chipset, logic circuit and/or data processing device. The memory 501 may include read-only memory (ROM), random access memory (RAM), flash memory, memory card, storage medium and/or other storage device. The transceiver 502 may include baseband circuitry to process radio frequency signals. When the embodiments are implemented in software, the techniques described herein can be implemented with modules (e.g., procedures, functions, and so on) that perform the functions described herein. The modules can be stored in the memory 501 and executed by the processor 503. The memory 501 can be implemented within the processor 503 or external to the processor 503 in which case those can be communicatively coupled to the processor 503 via various means as is known in the art.

In some embodiments, the transceiver 502 is configured to receive from an AMP device, a physical layer convergence protocol (PLCP) protocol data unit (PPDU) format, and the processor 503 is configured to decode the PPDU format, wherein the PPDU format includes a preamble with spreading and a media access control protocol data unit (MPDU). This can reduce complexity, reduce power consumption, and/or provide a backward compatibility.

FIG. 6 is an example of a communication method 600 for determining data by an AP according to an embodiment of the present disclosure. The communication method 600 for determining data is configured to implement some embodiments of the disclosure. Some embodiments of the disclosure may be implemented into the communication method 600 for determining data using any suitably configured hardware and/or software. In some embodiments, the communication method 600 for determining data includes: an operation 602, receiving, by an AP from an AMP device, a physical layer convergence protocol (PLCP) protocol data unit (PPDU) format, and an operation 604, decoding, by the AP, the PPDU format, wherein the PPDU format includes a preamble with spreading and a media access control protocol data unit (MPDU). This can reduce complexity, reduce power consumption, and/or provide a backward compatibility.

In some embodiments, the PPDU format may be a uplink (UL) PPDU) format. In some embodiments, the preamble with spreading includes a sync part with spreading. In some embodiments, the sync part has backward compatibility, and a sync sequence of the sync part is configured to indicate a following PPDU. In some embodiments, a bandwidth of the MPDU is narrower than a bandwidth of the sync part. In some embodiments, the sync sequence is pre-spread and pre-filtered.

In some embodiments, the preamble with spreading further includes a start of frame delimiter (SFD). In some embodiments, a bandwidth of the SFD is narrower than the bandwidth of the sync part. In some embodiments, a bandwidth of the SFD is equal to the bandwidth of the sync part. In some embodiments, the PPDU format further includes a header. In some embodiments, a bandwidth of the header is narrower than the bandwidth of the sync part. In some embodiments, a bandwidth of the header is equal to the bandwidth of the sync part. In some embodiments, the header includes none or at least one of signal part, a service part, or a length part.

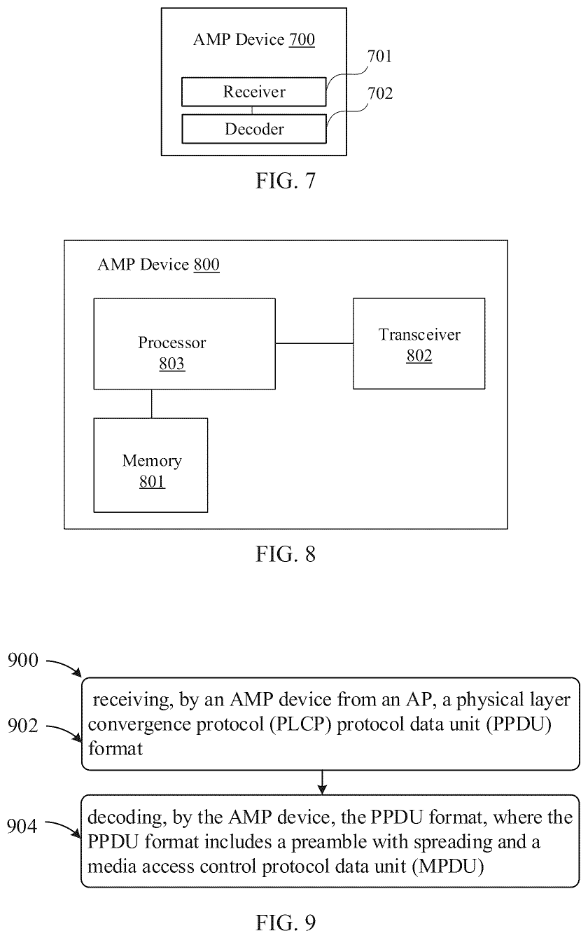

FIG. 7 illustrates an example of an AMP device 700 according to an embodiment of the present application. The AMP device 700 is configured to implement some embodiments of the disclosure. Some embodiments of the disclosure may be implemented into the AMP device 700 using any suitably configured hardware and/or software. The AMP device 700 includes a receiver 701 configured to receive from a second communication device, a physical layer convergence protocol (PLCP) protocol data unit (PPDU) format and a decoder 702 configured to decode the PPDU format, wherein the PPDU format includes a preamble with spreading and a media access control protocol data unit (MPDU). This can reduce complexity, reduce power consumption, and/or provide a backward compatibility.

FIG. 8 illustrates an example of an AMP device 800 according to an embodiment of the present disclosure. The AMP device 800 is configured to implement some embodiments of the disclosure. Some embodiments of the disclosure may be implemented into the AMP device 800 using any suitably configured hardware and/or software. The AMP device 800 may include a memory 801, a transceiver 802, and a processor 803 coupled to the memory 801 and the transceiver 802. The processor 803 may be configured to implement proposed functions, procedures and/or methods described in this description. Layers of radio interface protocol may be implemented in the processor 803. The memory 801 is operatively coupled with the processor 803 and stores a variety of information to operate the processor 803. The transceiver 802 is operatively coupled with the processor 803, and the transceiver 802 transmits and/or receives a radio signal. The processor 803 may include application-specific integrated circuit (ASIC), other chipset, logic circuit and/or data processing device. The memory 801 may include read-only memory (ROM), random access memory (RAM), flash memory, memory card, storage medium and/or other storage device. The transceiver 802 may include baseband circuitry to process radio frequency signals. When the embodiments are implemented in software, the techniques described herein can be implemented with modules (e.g., procedures, functions, and so on) that perform the functions described herein. The modules can be stored in the memory 801 and executed by the processor 803. The memory 801 can be implemented within the processor 803 or external to the processor 803 in which case those can be communicatively coupled to the processor 803 via various means as is known in the art.

In some embodiments, the transceiver 802 is configured to receive from an AP, a physical layer convergence protocol (PLCP) protocol data unit (PPDU) format, and the processor 803 is configured to decode the PPDU format, wherein the PPDU format includes a preamble with spreading and a media access control protocol data unit (MPDU). This can reduce complexity, reduce power consumption, and/or provide a backward compatibility.

FIG. 9 is an example of a communication method 900 for determining data by an AMP device according to an embodiment of the present disclosure. The communication method 900 for determining data is configured to implement some embodiments of the disclosure. Some embodiments of the disclosure may be implemented into the communication method 900 for determining data using any suitably configured hardware and/or software. In some embodiments, the communication method 900 for determining data includes: an operation 902, receiving, by an AMP device from an AP, a physical layer convergence protocol (PLCP) protocol data unit (PPDU) format, and an operation 904, decoding, by the AMP device, the PPDU format, wherein the PPDU format includes a preamble with spreading and a media access control protocol data unit (MPDU). This can reduce complexity, reduce power consumption, and/or provide a backward compatibility.

In some embodiments, the PPDU format may be a downlink (DL) PPDU) format. In some embodiments, the preamble with spreading includes a sync part with spreading. In some embodiments, the sync part has backward compatibility, and a sync sequence of the sync part is configured to indicate a following PPDU. In some embodiments, a bandwidth of the MPDU is narrower than a bandwidth of the sync part. In some embodiments, the sync sequence is pre-spread and pre-filtered.

In some embodiments, the preamble with spreading further includes a start of frame delimiter (SFD). In some embodiments, a bandwidth of the SFD is narrower than the bandwidth of the sync part. In some embodiments, a bandwidth of the SFD is equal to the bandwidth of the sync part. In some embodiments, the PPDU format further includes a header. In some embodiments, a bandwidth of the header is narrower than the bandwidth of the sync part. In some embodiments, a bandwidth of the header is equal to the bandwidth of the sync part. In some embodiments, the header includes none or at least one of signal part, a service part, or a length part.

### 802.11b PPDU:

802.11b PPDU is illustrated in FIG. 10, where a physical layer convergence procedure (PLCP) preamble is for synchronization and indication of frame start, and a PLCP header carries PPDU information such as modulation, data rate, etc. The data rate supported includes 1 Mbps and 2 Mbps. The information bits may be spread by 11-bit barker code and the channel bandwidth is 22 MHz.

### Examples of PPDU Format Design

### Preamble Design

Sync: The sync part contains 128 bits and is used for synchronization. The spreading for the sync part needs to be kept for backward compatibility. The snc part can also be used to indicate that the following PPDU is an AMP PPDU. A different sync sequence can be used for such indication and this sync sequency can be complement of the original sync sequence. Once a device receives such sync sequency, the deivce can do synchronization and further knows the current PPDU is the AMP PPDU. With such knowledge, the spreading for the following parts can be removed to reduce bandwidth.

SFD: SFD part may be a fixed sequency as F3A0hex. The same design principle as the sync part can be applied to the SFD part. A sequency different from F3A0hex, e.g., complement sequence, can be used to indicate a frame start of an AMP frame. The SFD part can either be pre-spread and pre-filtered same as the sync part or transmitted without spreading.

### Header Design

Signal: The signal field defines which type of modulation is used to receive the incoming MPDU and two rates, i.e., 1 Mbps and 2 Mbps, can be supported. For AMP, there is no need to support 2 Mbps. Thus, the signal part can be fixed as 0Ahex in existing 802.11b or 00hex. The signal part can also be removed to reduce the frame length since it does not carry any useful information when the sync and/or the SFD part indicate an AMP PPDU.

Service: The service part is reserved as 00hex in 802.11b . It can also be used to indicate the AMP PPDU. For example, when it is 00hex, it is 802.11 b PPDU and when it is a value other than 00hex, e.g., 01hex, it is AMP PPDU. It can also be removed to reduce frame length.

Length: The length part is used to indicate the length of the PPDU. In AMP design, the length of a PPDU can be fixed to reduce complexity. In this regard, the length part can be removed to reduce complexity. If multiple fixed frame length is assumed, the length part can be simplified. For example, if only 4 frame length values are expected, the number of bits for the length part can be reduced from 16 bits to 2 bits.

The entire header or part of header, e.g., only signal part and service prt, can be spread together with preamble.

It should be noted that the header part can also be pre-spread and pre-filtered same as the preamble part to further reduce complexity and power consumption.

### MPDU Design

MPDU carries information to be exchanged between AP and AMP devices. To reduce complexity and power consumption, the spreading can be removed.

It should be noted that even though some embodiments are focused on UL design, the same design concept and procedure can also be applied to DL. In some examples, the PPDU format may be an UL PPDU format. In some examples, the PPDU format may be a DL PPDU format.

FIG. 11 illustrates a PPDU format according to an embodiment of the present disclosure. FIG. 11 illustrates that, in some embodiments, the preamble with spreading includes a sync part with spreading. In some embodiments, the sync part has backward compatibility, and a sync sequence of the sync part is configured to indicate a following PPDU. In some embodiments, a bandwidth of the MPDU is narrower than a bandwidth of the sync part. In some embodiments, the sync sequence is pre-spread and pre-filtered. In some embodiments, the PPDU format may further include a header. In some embodiments, a bandwidth of the header is narrower than the bandwidth of the sync part. In some embodiments, the header includes none or at least one of signal part, a service part, or a length part.

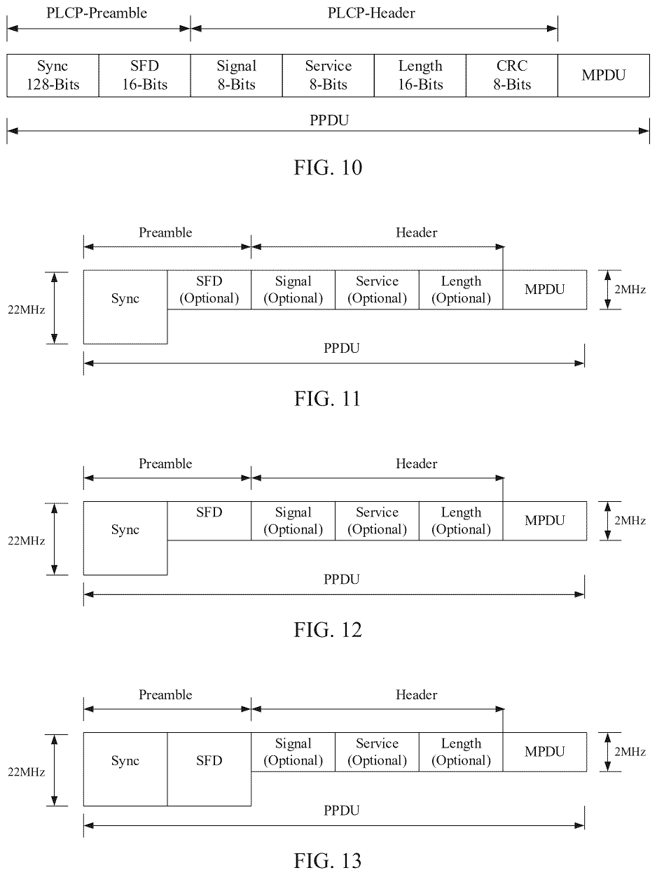

FIG. 12 illustrates a PPDU format according to an embodiment of the present disclosure. FIG. 12 illustrates that, in some embodiments, the preamble with spreading includes a sync part with spreading. In some embodiments, the sync part has backward compatibility, and a sync sequence of the sync part is configured to indicate a following PPDU. In some embodiments, a bandwidth of the MPDU is narrower than a bandwidth of the sync part. In some embodiments, the sync sequence is pre-spread and pre-filtered. In some embodiments, the preamble with spreading further includes a start of frame delimiter (SFD). In some embodiments, a bandwidth of the SFD is narrower than the bandwidth of the sync part. In some embodiments, the PPDU format may further include a header. In some embodiments, a bandwidth of the header is narrower than the bandwidth of the sync part. In some embodiments, the header includes none or at least one of signal part, a service part, or a length part.

FIG. 13 illustrates a PPDU format according to an embodiment of the present disclosure. FIG. 13 illustrates that, in some embodiments, the preamble with spreading includes a sync part with spreading. In some embodiments, the sync part has backward compatibility, and a sync sequence of the sync part is configured to indicate a following PPDU. In some embodiments, a bandwidth of the MPDU is narrower than a bandwidth of the sync part. In some embodiments, the sync sequence is pre-spread and pre-filtered. In some embodiments, the preamble with spreading further includes a start of frame delimiter (SFD). In some embodiments, a bandwidth of the SFD is equal to the bandwidth of the sync part. In some embodiments, the PPDU format may further includes a header. In some embodiments, a bandwidth of the header is narrower than the bandwidth of the sync part. In some embodiments, the header includes none or at least one of signal part, a service part, or a length part.

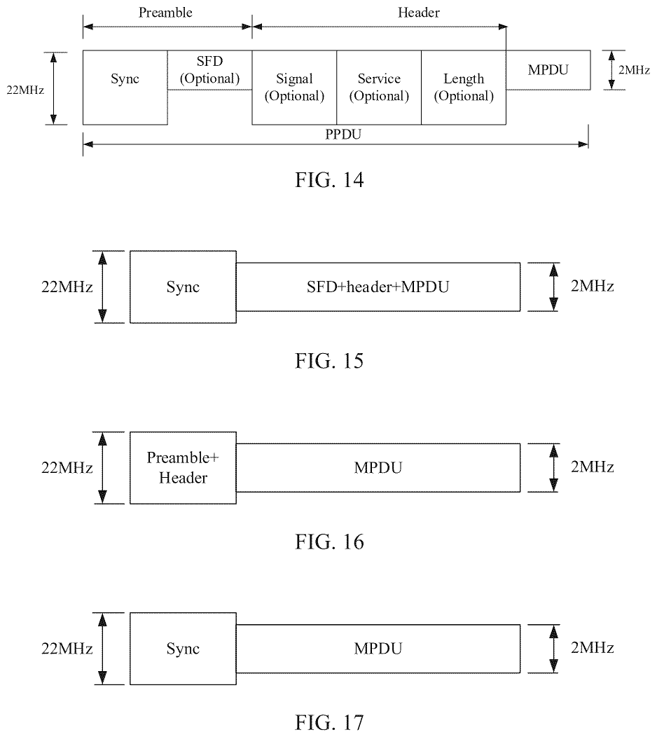

FIG. 14 illustrates a PPDU format according to an embodiment of the present disclosure. FIG. 14 illustrates that, in some embodiments, the preamble with spreading includes a sync part with spreading. In some embodiments, the sync part has backward compatibility, and a sync sequence of the sync part is configured to indicate a following PPDU. In some embodiments, a bandwidth of the MPDU is narrower than a bandwidth of the sync part. In some embodiments, the sync sequence is pre-spread and pre-filtered. In some embodiments, the preamble with spreading may further include a start of frame delimiter (SFD). In some embodiments, a bandwidth of the SFD is narrow than the bandwidth of the sync part. In some embodiments, the PPDU format further includes a header. In some embodiments, a bandwidth of header is equal to the bandwidth of the sync part. In some embodiments, the header includes none or at least one of signal part, a service part, or a length part.

FIG. 15 illustrates a PPDU format according to an embodiment of the present disclosure. FIG. 15 illustrates that, in some embodiments, only the sync part is spread to 22 MHz and the rest parts are transmitted without spreading so that the complexity and power consumption can be reduced. However, AMP devices still need to handle 22 MHz bandwidth for the sync part. In order to further reduce complexity, considering the sync sequence is a pre-designed sequence, it can be pre-spread and pre-filtered and the values after these procedures can be stored in the memory of the AMP device. Therefore, the AMP devices do not need to any further operation other than load the values from its own memory and the complexity and power consumption can be further reduced.

FIG. 16 illustrates a PPDU format according to an embodiment of the present disclosure. FIG. 16 illustrates that, in some embodiments, the entire header or part of header, e.g., only signal and service parts, can be spread together with the preamble part.

FIG. 17 illustrates a PPDU format according to an embodiment of the present disclosure. FIG. 17 illustrates that, in some embodiments, MPDU carries information to be exchanged between AP and AMP devices. To reduce complexity and power consumption, the spreading can be removed. A simple design can be as follows, that is PPDU with the sync part with spreading and MPDU only.

### Use Cases

In some embodiments, some use cases can implement the first communication device, the AP, the AMP device, the communication method in some embodiments in FIG. 1 to FIG. 17 using any suitably configured hardware and/or software. The use case may include alt least one of the following:

### Use Case 1: Smart Manufacturing

Smart manufacturing plays a critical role in increasing productivity and improving sustainability. The key to smart manufacturing is inter-connectivity and inter-operability between assets, storage tanks, materials and other passive objects in factories or industrial areas, enabled by wireless identification and sensing. In smart manufacturing, identification is an essential service mainly for asset management and worker tracking, where labels can be attached to human beings or assets including production materials, storage tanks, containers, etc. The following functionalities can be provided:

Inventory check: once tags are read remotely, the ID of the item to which the tag is attached can be acquired and traced as well as the information associated with the ID, e.g., position, product number, etc. Such information can then be further used for other purpose, e.g., supply chain management, anti-counterfeiting, etc.

Attendance check: once a worker enters or leaves a specific area of a factory or a working spot, the tag attached to him can be read and attendance can be automatically checked.

Real-time inspection and tracing: a product can be assembled and moved along multiple steps in a line of machines and workers. Real-time inspection and tracing are needed to guarantee that each machine or worker, that is performing a particular job must finish the job before the product moves to the next step in the production line.

Environmental sensing and monitoring are needed to collect real-time temperature and humidity information for production lines, computing and data centres and other equipment. The weight and moving speed of a product in a production line can be collected via motion and pressure detection sensors. In addition, to maintain safety within a factory, gas leakage in gas tanks and pipelines can also be detected by such sensing networks. This use case requires ultra-small size, ultra-low cost and power consumption labels so that they can be deployed in a very high density. In addition, the battery-less devices can enable maintenance-free operation.

### Use Case 2: Data Center

The data center is the bedrock of modern ICT infrastructure, running software and processing data. The management network is essential to improve the reliability and efficiency, thus guaranteeing the safe and reliable operating conditions. Data centers are unique from all other building types, which need to be managed intelligently and comprehensively with the following functionalities:

Environmental monitoring to capture data on temperature, pressure, humidity and air flow etc., and highlight potential inefficiencies.

Facility monitoring to provide visibility into the entire power chain from aa generator down to a specific outlet on an intelligent cabinet power unit, and diagnose potential facility problems.

Asset management to maintain a centralized database that houses all of the IT and facility asset information including where the asset is located and how it is connected to other assets.

### Use Case 3: Logistics/Warehouse

In logistics, an inventory check is needed to view all products and identify any missing assets and discrepancies within the inventory. Packages are stored in containers such as cartons and the cartons are normally piled in a warehouse. A pile of cartons in a single storage location can be more than 10 m long and up to 8 m high.

In sorting systems the following functionalities maybe provided:

Accurate label identification for closely adjacent items on the conveyor system.

Fast label identification of the items on the conveyor belt that moves at a speed of 1.5-2 m/s.

Real-time monitoring and related information acquisition for the items on the conveyor system.

Environmental monitoring of temperature, humidity, etc. for specific items such as cold-chain transportation goods.

### Use Case 4: Smart Home

In a smart home, many devices such as smartphones, tablets, door locks, thermostats, home monitors, etc. are connected with each other. Low energy consumption and maintenance-free devices can be used for sensing and monitoring. For home environment sensing, such as temperature, humidity, etc., once the sensed information is collected by a controlling node, the heater, air-conditioner and (de)humidifier can be switched on/off automatically accordingly to adjust the temperature and humidity to a comfortable level. Such devices can also be used for home safety. For example, once gas leakage happens, a gas detector can send an alert to warn the home owner. Similarly, if a smoke detector senses there is a fire, it can automatically send the alert. In addition, motion detector is needed to detect the intruders and send alert to the home owner. Another important functionality needed is to locate keys, wallets and other personal belongs with attached labels.

### Use Case 5: Smart Agriculture

Smart agriculture focuses on providing the industry with the infrastructure to leverage advanced technology for tracking, monitoring, automating and analyzing operations. Similar to smart home, low energy consumption and maintenance-free devices can be used for sensing and monitoring, such as monitoring of soil moisture, soil fertility, temperature, wind speed, plant growth etc. For example, once the soil moisture is sensed, the irrigation system can be controlled to increase or decrease the supply of water to land or crops. Asset management for agricultural facilities can also be done by reading the labels attached to those facilities remotely.

### Use Case 6: Indoor Positioning

For indoor positioning, reference tags with known location can be densely deployed indoor to establish a navigating and positioning system that has a wide range of potential applicable venues such as giant shopping malls, parking, smart factories, warehouses, etc. Shopping centers offer a wide range of services and products, including large supermarkets, a collection of retail stores, restaurants, banks, theatres, fitness and leisure facilities, underground parking areas, professional offices and other establishments. Many giant shopping centers have been established all over the world, each can occupy an area of tens to hundreds of thousands m², composed of one or multiple buildings, each of which has multiple-story both over and underground. While enjoy various services, people often have troubles in finding a vacant parking spot or his/her own car, a target shop/restaurant or a target item in a supermarket. The reference tags can be evenly distributed with high density, e.g., 2-meter intervals, within the entire shopping center on each floor and in each room. Indoor positioning can be enabled by a handheld device (e.g., smartphone), which can communicate with the reference tags.

### Use Case 7: Smart Power Grid:

Sub-station plays a vital role in the electrical power system to guarantee the continuity of the electrical power supply. It is deployed as transmission sub-station and distribution sub-station and one sub-station covers around 50000 m² service area. The sub-stations transform voltage from high to low, or the reverse, or perform some other important functions. Massive number of sensors and meters need to be deployed all over the sub-stations to monitor and report temperature, humidity, etc. Another important part of electrical power system is high voltage transmission lines that deliver electricity over long distances to reduce the amount of energy lost during the distance. Sensing and monitoring of high voltage transmission lines and towers can help to detect operation faults such as power leakage, tower tilting, etc. Such operation faults not only will stop the power supply, leading to large scale blackout, they might also cause damage to the very expensive equipment. Since many sensors and meters need to be deployed in the inaccessible locations, they need to be maintenance free and ideally battery-less to support long life span.

### Use Case 8: Fresh Food Supply Chain

In this use case, a large food supplier monitors its food supply chain by adding a simple and small form factor device (sticker) on to each of the Reusable Transport Item (RTIs) used for storing and transporting of the food.

In some embodiments, the AMP device 700 of FIG. 7 and/or the AMP device 800 of FIG. 8 may be an AMP IoT device. In some examples, the AMP IoT device may be an AMP-only IoT device or an AMP-assisted IoT device.

### AMP-Only IoT Device

For AMP-only IoT device, the potential functional requirements include:

Supported operation band: It may be helpful to achieve low complexity and low power consumption by lower frequency band. This is due to its small channel bandwidth and good propagation property in lower frequency band. Therefore, sub 1 GHz shall be considered with high priority. The 2.4 GHz can also be considered since it is the mature frequency band widely used.

Constraints of power consumption: Since ambient power is used and energy harvester with small size can be utilized due to the small size restriction of the device, the power can be harvested is very limited. Therefore, ultra-low power consumption, e.g., less than 1 mW can be considered as the design target for AMP IoT.

Coexistence: Irrespective of sub 1GHz or 2.4 GHz, AMP-only IoT device will share same frequency band(s) with legacy Wi-Fi devices. Therefore, backward compatibility and coexistence with legacy devices shall be supported. The regulation of these frequency band(s) shall be followed.

Support energy harvesting: In order to achieve battery-less (i.e., not using conventional battery), it will use ambient power to drive itself and to communicate with the AP. Therefore, energy harvesting should be supported by the AMP-only devices. For different use cases, different ambient power may be available thus different energy harvester can be supported based on the suitable ambient power for a specific use case.

Coverage: As discussed in the use cases and requirements in the above embodiments, up to 30 m for indoor scenario and up to 100 m for outdoor scenario are required.

### AMP-Assisted IoT Device:

The potential functional requirements for AMP-assisted IoT device include:

Supported operation band: With similar capabilities to the current Wi-Fi devices, it is easy for an AMP-assisted IoT device to operate on the current frequency bands such as 2.4GHz and sub 1GHz. For example, if it is optimized in addition to the 802.11ah devices using sub 1GHz, the AMP-assisted IoT device can also use sub 1GHz to support energy harvesting.

In order to achieve maintenance free operation, it may use ambient power to sustain itself and to communicate with the AP. In order to fulfill the required higher power consumption compared with that of AMP-only devices, the energy harvester shall be able to provide a higher output power, e.g., more than 10 mWs.

Coverage: Similar coverage as the current Wi-Fi devices can be expected, e.g., up to 30 m for indoor case and up to 200 m for outdoor case (note that for 802.11ah, it can be up to 1 km).

Commercial interests for some embodiments are as follows. 1. Solving the backward compatibility problem between the legacy device and AMP devices. 2. Reducing the complexity. 3. Reducing power consumption. Some embodiments of the present disclosure can be used in many applications. Some embodiments of the present disclosure are used by chipset vendors, video system development vendors, automakers including cars, trains, trucks, buses, bicycles, moto-bikes, helmets, and etc., drones (unmanned aerial vehicles), smartphone makers, communication devices for public safety use, AR/VR/MR device maker for example gaming, conference/seminar, education purposes. Some embodiments of the present disclosure are a combination of “techniques/processes” that can be adopted in video standards to create an end product. Some embodiments of the present disclosure propose technical mechanisms. The at least one proposed solution, method, system, and apparatus of some embodiments of the present disclosure may be used for current and/or new/future standards regarding communication systems such as AMP tag based communication systems. Compatible products follow at least one proposed solution, method, system, and apparatus of some embodiments of the present disclosure. The proposed solution, method, system, and apparatus are widely used in AMP related products, AP related products, and/or communication systems. With the implementation of the at least one proposed solution, method, system, and apparatus of some embodiments of the present disclosure, at least one modification to methods and apparatus for PPDU design for DSSS based AMP are considered for standardizing.

In summary, AMP device is a huge market in many scenarios, such as smart home, smart manufacturing, logistics/warehouse, etc. AMP devices opens a whole new market due to its ultra-low cost and maintenance free features. Some embodiments of the present disclosure can be used when cost efficient, maintenance free and high accuracy AMP device is needed and the interested group include AMP IoT device vendors, companies running large shopping malls, warehouse/logistics companies, and smart home service providers. Some embodiments of the present disclosure are a technique/process that can be applied to AMP tag based communication systems. Some embodiments of the present disclosure propose methods and apparatus for PPDU design for DSSS based AMP with narrow band operation to reduce the complexity and power consumption while further compatible with existing 802.11b system.

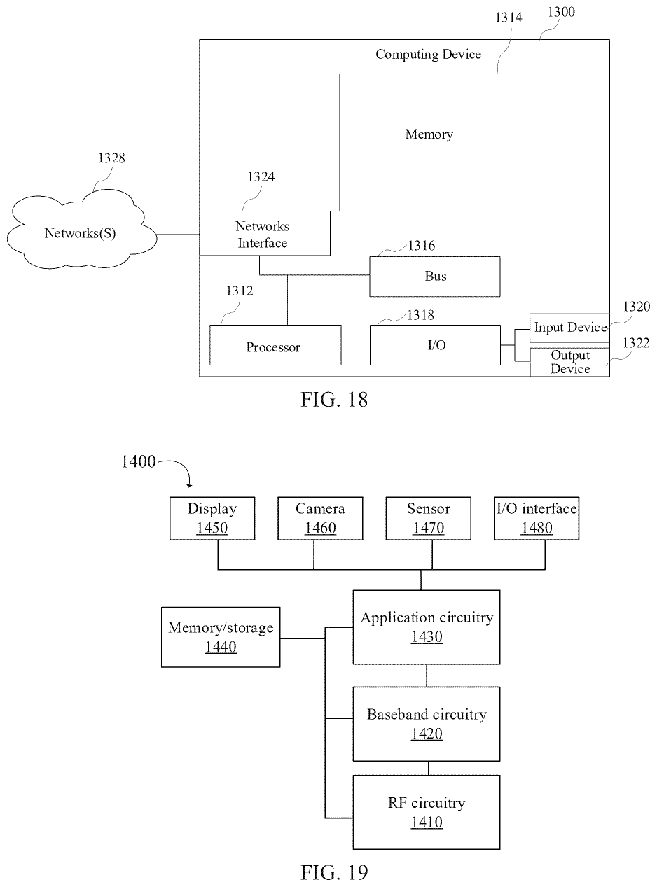

FIG. 18 is an example of a computing device 1300 according to an embodiment of the present disclosure. Any suitable computing device can be used for performing the operations described herein. For example, FIG. 18 illustrates an example of the computing device 1300 that can implement the first communication device, the AP, the AMP device, the communication method in some embodiments in FIG. 1 to FIG. 17 using any suitably configured hardware and/or software. In some embodiments, the computing device 1300 can include a processor 1312 that is communicatively coupled to a memory 1314 and that executes computer-executable program code and/or accesses information stored in the memory 1314. The processor 1312 may include a microprocessor, an application-specific integrated circuit (“ASIC”), a state machine, or other processing device. The processor 1312 can include any of a number of processing devices, including one. Such a processor can include or may be in communication with a computer-readable medium storing instructions that, when executed by the processor 1312, cause the processor to perform the operations described herein.

The memory 1314 can include any suitable non-transitory computer-readable medium. The computer-readable medium can include any electronic, optical, magnetic, or other storage device capable of providing a processor with computer-readable instructions or other program code. Non-limiting examples of a computer-readable medium include a magnetic disk, a memory chip, a read-only memory (ROM), a random access memory (RAM), an application specific integrated circuit (ASIC), a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C#, visual basic, java, python, perl, javascript, and actionscript.

The computing device 1300 can also include a bus 1316. The bus 1316 can communicatively couple one or more components of the computing device 1300. The computing device 1300 can also include a number of external or internal devices such as input or output devices. For example, the computing device 1300 is illustrated with an input/output (“I/O”) interface 1318 that can receive input from one or more input devices 1320 or provide output to one or more output devices 1322. The one or more input devices 1320 and one or more output devices 1322 can be communicatively coupled to the I/O interface 1318. The communicative coupling can be implemented via any suitable manner (e.g., a connection via a printed circuit board, connection via a cable, communication via wireless transmissions, etc.). Non-limiting examples of input devices 1320 include a touch screen (e g., one or more cameras for imaging a touch area or pressure sensors for detecting pressure changes caused by a touch), a mouse, a keyboard, or any other device that can be used to generate input events in response to physical actions by a user of a computing device. Non-limiting examples of output devices 1322 include a liquid crystal display (LCD) screen, an external monitor, a speaker, or any other device that can be used to display or otherwise present outputs generated by a computing device.

The computing device 1300 can execute program code that configures the processor 1312 to perform one or more of the operations described above with respect to FIGS. 4-12. The program code may be resident in the memory 1314 or any suitable computer-readable medium and may be executed by the processor 1312 or any other suitable processor.

The computing device 1300 can also include at least one network interface device 1324. The network interface device 1324 can include any device or group of devices suitable for establishing a wired or wireless data connection to one or more data networks 1328. Non limiting examples of the network interface device 1324 include an Ethernet network adapter, a modem, and/or the like. The computing device 1300 can transmit messages as electronic or optical signals via the network interface device 1324.

FIG. 19 is a block diagram of an example of a communication system 1400 according to an embodiment of the present disclosure. Embodiments described herein may be implemented into the communication system 1400 using any suitably configured hardware and/or software. FIG. 19 illustrates the communication system 1400 including a radio frequency (RF) circuitry 1410, a baseband circuitry 1420, an application circuitry 1430, a memory/storage 1440, a display 1450, a camera 1460, a sensor 1470, and an input/output (I/O) interface 1480, coupled with each other at least as illustrated.

The application circuitry 1430 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system. The communication system 1400 can execute program code that configures the application circuitry 1430 to perform one or more of the operations described above with respect to FIGS. 3, 6, and 9. The program code may be resident in the application circuitry 1430 or any suitable computer-readable medium and may be executed by the application circuitry 1430 or any other suitable processor.

The baseband circuitry 1420 may include circuitry such as, but not limited to, one or more single-core or multi-core processors. The processors may include a baseband processor. The baseband circuitry may handle various radio control functions that may enable communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 1420 may include circuitry to operate with signals that are not strictly considered as being in a baseband frequency. For example, in some embodiments, baseband circuitry may include circuitry to operate with signals having an intermediate frequency, which is between a baseband frequency and a radio frequency. The RF circuitry 1410 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 1410 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the first communication device, the AP, the AMP device, in some embodiments in FIG. 1 to FIG. 17 may be embodied in whole or in part in one or more of the RF circuitry, the baseband circuitry, and/or the application circuitry. As used herein, “circuitry” may refer to, be part of, or include an application specific integrated circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the application circuitry, and/or the memory/storage may be implemented together on a system on a chip (SOC). The memory/storage 1440 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 1480 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface. In various embodiments, the sensor 1470 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 1450 may include a display, such as a liquid crystal display and a touch screen display. In various embodiments, the communication system 1400 may be a mobile computing device such as, but not limited to, a laptop computing device, a tablet computing device, a netbook, an ultrabook, a smartphone, an AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a non-transitory readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the exemplary embodiments, it is understood that the present disclosure is not limited to the disclosed embodiments but is intended to cover various arrangements made without departing from the scope of the broadest interpretation of the appended claims.

What is claimed is:

1. A wireless communication method for determining data, comprising:
receiving, by a first communication device from a second communication device, a physical layer convergence protocol (PLCP) protocol data unit (PPDU) format; and
decoding, by the first communication device, the PPDU format, wherein the PPDU format comprises a preamble with spreading and a media access control protocol data unit (MPDU).

2. The wireless communication method for determining data according to claim 1, wherein the preamble with spreading comprises a sync part with spreading;
wherein the sync part has backward compatibility, and a sync sequence of the sync part is configured to indicate a following PPDU.

3. The wireless communication method for determining data according to claim 2, wherein a bandwidth of the MPDU is narrower than a bandwidth of the sync part.

4. The wireless communication method for determining data according to claim 2, wherein the sync sequence is pre-spread and pre-filtered.

5. The wireless communication method for determining data according to claim 1, wherein the PPDU format further comprises a header.

6. The wireless communication method for determining data according to claim 5, wherein a bandwidth of the header is narrower than the bandwidth of the sync part; or
a bandwidth of the header is equal to the bandwidth of the sync part.

7. The wireless communication method for determining data according to claim 5, wherein the header comprises none or at least one of signal part, a service part, or a length part.

8. A first wireless communication device, comprising:
a receiver configured to receive from a second communication device, a physical layer convergence protocol (PLCP) protocol data unit (PPDU) format; and
a decoder configured to decode the PPDU format, wherein the PPDU format comprises a preamble with spreading and a media access control protocol data unit (MPDU).

9. The first wireless communication device according to claim 8, wherein the preamble with spreading comprises a sync part with spreading;
wherein the sync part has backward compatibility, and a sync sequence of the sync part is configured to indicate a following PPDU.

10. The first wireless communication device according to claim 9, wherein a bandwidth of the MPDU is narrower than a bandwidth of the sync part.

11. The first wireless communication device according to claim 9, wherein the sync sequence is pre-spread and pre-filtered.

12. The first wireless communication device according to claim 8, wherein the PPDU format further comprises a header.

13. The first wireless communication device according to claim 12, wherein a bandwidth of the header is narrower than the bandwidth of the sync part; or
a bandwidth of the header is equal to the bandwidth of the sync part.

14. The first wireless communication device according to claim 12, wherein the header comprises none or at least one of signal part, a service part, or a length part.

15. A non-transitory machine-readable storage medium having stored thereon instructions that, when executed by a computer, cause the computer to perform:
receiving a physical layer convergence protocol (PLCP) protocol data unit (PPDU) format from a second communication device; and
decoding the PPDU format, wherein the PPDU format comprises a preamble with spreading and a media access control protocol data unit (MPDU).

16. The non-transitory machine-readable storage medium according to claim 15, wherein the preamble with spreading comprises a sync part with spreading;
wherein the sync part has backward compatibility, and a sync sequence of the sync part is configured to indicate a following PPDU.

17. The non-transitory machine-readable storage medium according to claim 16, wherein a bandwidth of the MPDU is narrower than a bandwidth of the sync part;
and/or
the sync sequence is pre-spread and pre-filtered.

18. The non-transitory machine-readable storage medium according to claim 15, wherein the PPDU format further comprises a header.

19. The non-transitory machine-readable storage medium according to claim 18, wherein a bandwidth of the header is narrower than the bandwidth of the sync part; or
a bandwidth of the header is equal to the bandwidth of the sync part.

20. The non-transitory machine-readable storage medium according to claim 18, wherein the header comprises none or at least one of signal part, a service part, or a length part.
